(19) United States
(12) Patent Application Publication
(10) Pub. No.: US 2023/0166999 A1
(43) Pub. Date: Jun. 1, 2023

(54) METHODS FOR MANUFACTURING LOW LIQUIDUS VISCOSITY SHEET GLASS

(71) Applicant: CORNING INCORPORATED, CORNING, NY (US)

(72) Inventors: Gilbert De Angelis, Lindley, NY (US); Nils Paul Fornell, Harrodsburg, KY (US); Allan Mark Fredholm, Vulaines sur Seine (FR); Xiaoju Guo, Pittsford, NY (US); Shawn Rachelle Markham, Harrodsburg, KY (US); William Anthony Sheehy, Painted Post, NY (US); Pascal Verdurme, Veneux les Sablons (FR); Rui Zhang, Corning, NY (US)

(21) Appl. No.: 17/921,179

(22) PCT Filed: Apr. 14, 2021
(86) PCT No.: PCT/US2021/027238

§ 371 Date: Oct. 25, 2022

Related U.S. Application Data
(60) Provisional application No. 63/017,257, filed on Apr. 29, 2020.

(51) Int. Cl. C03B 18/16; C03B 18/06; C03B 17/06

(52) U.S. Cl. CPC C03B 18/16; C03B 18/06; C03B 17/067; C03B 17/064

(57) ABSTRACT

Disclosed are various methods and apparatus for forming sheet glass from molten glass whose liquidus viscosity is <5 kP. Also disclosed is a roller for receiving and cooling continuously-fed ribbon of glass whose liquidus viscosity is <5 kP onto the roller's outer surface, where the roller is configured to be maintained at a predetermined temperature and can be rotated at a predetermined speed so that the glass ribbon comes in contact with the roller for a set duration of time and rolls off the roller at the end of the set duration of time.

### CROSS REFERENCES

This application claims the benefit of priority under 35 U.S.C. § 119 of U.S. Provisional Application Ser. No. 63/017,257 filed on Apr. 29, 2020, the content of which is relied upon and incorporated herein by reference in its entirety.

### BACKGROUND

To meet the ever-increasing demand for improved robustness of display cover glasses for modern consumer electronic devices, such as smart phones and tablets, glass manufacturers are developing glass with higher fracture toughness with deeper stress profiles. Some of the advancements in this area have been made possible with the use of glass compositions with higher lithium content. One downside of such glass formulations, however, is their drastically lower liquidus viscosity (often <5 kP) which is often not compatible with glass forming processes. Therefore, there is a need for improved glass forming processes that can accommodate lower liquidus viscosity.

### SUMMARY

A method for forming a glass sheet from molten glass is provided. The method comprises forming a glass ribbon of glass having a liquidus viscosity <5 kP; and flowing the glass ribbon on a surface of a molten metal bath contained in a float tank having a length defined between a first end and a second end that is no more than 500 cm, wherein the glass ribbon flows over the length of the float tank in a flow direction from the first end to the second end such that the glass ribbon reaches its equilibrium thickness at the second end and the viscosity of the glass ribbon at the second end is at least 100 kP.

Another method for forming a glass sheet from molten glass is also provided. The method comprises: forming a glass ribbon from a molten glass whose liquidus viscosity is <5 kP; and delivering the glass ribbon onto a roller, where the roller is maintained at a predetermined temperature and is rotated at a predetermined speed so that the glass ribbon is in contact with the roller for a set duration of time and rolls off the roller at the end of the set duration of time, whereby the portion of the glass ribbon that is rolling off the roller has a viscosity of at least 100 kP.

In another aspect, an embodiment of an apparatus for forming a glass sheet from molten glass is disclosed. The apparatus comprises a roller for receiving and cooling continuously-fed glass ribbon whose liquidus viscosity is <5 kP, onto the roller's outer surface, and a glass ribbon delivery device configured for continuously delivering the glass ribbon to the roller. The roller is configured to be maintained at a predetermined temperature and can be rotated at a predetermined speed so that the glass ribbon comes in contact with the roller for a set duration of time and rolls off the roller at the end of the set duration of time, whereby the portion of the glass ribbon that is rolling off the roller will attain a viscosity of at least 100 kP.

Another embodiment of an apparatus for forming a glass sheet from molten glass whose liquidus viscosity is <5 kP is also disclosed. The apparatus comprises a pair of rollers for receiving and cooling continuously-fed glass ribbon onto the pair of rollers' outer surfaces between the two rollers, and a glass ribbon delivery device configured for continuously delivering the glass ribbon to the pair of rollers. The two rollers are maintained at a predetermined temperature and is rotated at a predetermined speed so that the glass ribbon is in contact with the two rollers for a set duration of time and rolls off the two rollers at the end of the set duration of time, whereby the portion of the glass ribbon that is rolling off the two rollers has a viscosity of at least 100 kP.

### BRIEF DESCRIPTION OF THE DRAWINGS

These figures are provided for the purposes of illustration, it being understood that the embodiments disclosed and discussed herein are not limited to the arrangements and instrumentalities shown. The figures are schematic and they are not to scale. They are not intended to show dimensions or actual proportions.

FIG. 1 is an illustration of an overall process layout for a hybrid float bath and down-draw process for low liquidus viscosity glass according to the present disclosure.

FIG. 2 is an illustration of a top down view of the process layout shown in FIG. 1.

FIG. 3 is an illustration of the molten tin bath and lift out to down-draw process of the present disclosure.

FIG. 4 is an illustration of an example of horizontal delivery glass ribbon extraction method.

FIG. 5 is an illustration of an example of vertical delivery glass ribbon extraction method.

FIGS. 5A-5D are illustrations of some examples of vertical glass ribbon dispensers.

FIG. 6A is an illustration of a single-sided cooling roll with draw.

FIG. 6B is an illustration of a double-sided cooling roll with draw.

FIG. 7A is an illustration of an internal cooling arrangement for the cooling roll.

FIGS. 7B and 7C are illustrations of a water nozzle that can be used for the internal cooling of the cooling roll.

FIG. 7D is an illustration showing a cross-sectional view of the cooling roll of the present disclosure.

FIG. 8 is a flowchart of a method for forming a glass sheet from molten low liquidus viscosity glass according to an embodiment.

FIG. 9 is a flowchart of a method for forming a glass sheet from molten low liquidus viscosity glass according to another embodiment.

While this description can include specifics, these should not be construed as limitations on the scope, but rather as descriptions of features that can be specific to particular embodiments.

### DETAILED DESCRIPTION

Various embodiments for improved glass forming processes are described with reference to the figures, where like elements have been given like numerical designations to facilitate an understanding.

It also is understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, the group can comprise, consist essentially of, or consist of any number of those elements recited, either individually or in combination with each other.

Similarly, whenever a group is described as consisting of at least one of a group of elements or combinations thereof, the group can consist of any number of those elements recited, either individually or in combination with each other. Unless otherwise specified, a range of values, when recited, includes both the upper and lower limits of the range. As used herein, the indefinite articles “a,” and “an,” and the corresponding definite article “the” mean “at least one” or “one or more,” unless otherwise specified.

The term “liquidus viscosity” as used herein, refers to the shear viscosity of the glass composition at its liquidus temperature. The liquidus viscosity is measured according to ASTM C829 standard, gradient boat method.

The term “liquidus temperature” as used herein, refers to the highest temperature at which devitrification occurs in the glass composition. The liquidus temperature is measured according to ASTM C829 standard, gradient boat method.

Those skilled in the art will recognize that many changes can be made to the embodiments described while still obtaining the beneficial results of the disclosure. It also will be apparent that some of the desired benefits of the present disclosure can be obtained by selecting some of the described features without using other features. Accordingly, those of ordinary skill in the art will recognize that many modifications and adaptations are possible and can even be desirable in certain circumstances and are part of the disclosure. Thus, the following description is provided as illustrative of the principles of the present disclosure and not in limitation thereof.

Disclosed herein are various embodiments of novel methods and systems for forming glass sheets from glass formulation that has low liquidus viscosity. As used herein low liquidus viscosity means <5 kP. In one embodiment, the process delivers molten low liquidus viscosity glass to a down-draw process from a modified float bath as a method for manufacturing high quality cover glass from low liquidus viscosity glass composition.

In other embodiments, molten low liquidus viscosity glass is delivered with a uniform ribbon thickness via a horizontal delivery system or a vertical delivery system to a novel rapid cooling mechanism (an actively cooled roller or a pair of actively cooled rollers) to form a glass ribbon having a workable viscosity at least 100 kP, preferably about 200 kP, and up to 1 MP.

In the modified float bath and down-draw process system, a molten tin bath for spreading and forming the molten glass to a uniform thickness ribbon has a length of no more than 500 cm which is substantially shorter than the conventional float glass process in which the float bath is tens of meters and up to 60 meters long. The hybrid float bath and down-draw process system also comprises an apparatus to transition the glass ribbon having low liquidus viscosity (<5 kP) from the horizontal surface of the molten tin bath to the vertical orientation in the feed portion of a down-draw machine such that the ribbon can be drawn to a desired thickness below 7 mm thickness and to cut the ribbon into individual sheets or spooled on rolls depending on the product thickness and application. This process departs from a typical float process by minimizing the free surface (the glass surface that is exposed to air) of the glass delivery system and ribbon and therefore minimizing the potential glass volatilization effects (loss of components the glass composition by vaporization) of in the glass ribbon delivery system. Minimizing the free surface of the glass delivery system and ribbon also introduces an alternative flow control methodology compared to a typical channel with a tweel and can minimize top streak type defects. A tweel is a refractory block used in float process to regulate the glass flow from the furnace to the molten metal bath. The tweel is generally inserted from the top and flow can be controlled by adjusting its drop height.

Using a float bath that is no more than 500 cm long for glass spreading decreases the contact time of the glass ribbon with the molten tin bath and reduce tin diffusion into the glass ribbon through the bottom surface of the glass ribbon that contacts the molten tin. This process is configured so that the viscous to elastic transition point of the glass ribbon is in the vertical draw portion of the process. Glass transfers from equilibrium liquid state to super cooled state (solid) and its mechanical behavior can be described by the viscous to the viscoelastic. Most of the mechanical attributes depend on the history of the transition between viscous to elastic state. To make flat thin glass sheets, the viscous to elastic transition of the glass needs to be carefully controlled so that residual stress and warping are minimized. By moving the viscous to elastic transition point to the vertical draw portion can reduce the effects of micro-corrugation and surface waviness that are observed on a traditional float or specialty float lines.

Also, having the float bath shifts the glass ribbon to the vertical orientation early in the process. This reduces the potential for surface condensation drip defects while enabling increased temperatures in the float bath process to enable delivery of lower liquidus viscosity compositions. The float bath temperature needs to be higher than the liquidus temperature for low liquidus viscosity compositions to avoid growing devit in the float bath.

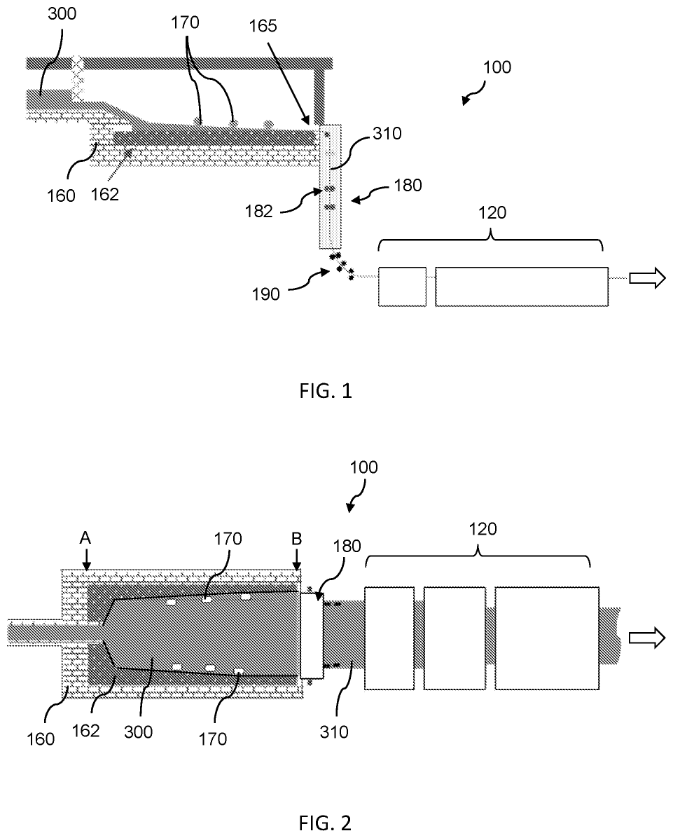

FIG. 1 illustrates an overall process layout for an example of the float bath and down-draw process 100 for forming glass sheets from low liquidus viscosity glass according to an embodiment of the present disclosure. The glass manufacturing apparatus 100 comprises a float tank 160, a down-draw (stretching and cooling) process 180, and various downstream process stations 120 (e.g. inspection, bead removal, cross cutting, and packing, etc.). The float tank 160 holds a molten metal bath 162, such as molten tin or the like. The length L_{M} of the molten metal bath is not too long so that the low liquidus viscosity glass ribbon does not spread too thin. Preferably L_{M} can be from 200 cm to 1000 cm long. More preferably, L_{M} is 500 cm (±10 cm). The float tank 160 receives a flow of molten low liquidus viscosity glass 300 at its entrance and outputs a glass ribbon 310 at its exit end 165.

The down-draw process 180 utilizes a series of rollers 182 and temperature control 181 to stretch and cool the glass ribbon 310 into a desired dimension. The temperature control 181 in a down-draw process provides controlled cooling of the glass as it transitions from the molten state to the solid state. This process is carefully controlled. The temperature control 181 can comprise heating mechanisms to control the cooling rate. The temperature controlled zone of the down-draw process 180 can also comprise annealing and pulling zones to relieve internal stress in the solidified glass ribbon. The various downstream process stations 120 then perform such processes as inspection, bead removal, cross cutting, and packing as needed. Optionally, between the down-draw process 180 and the downstream process stations 120, a buffer zone 190 can be provided. The buffer zone 190 can provide process isolation between the down-draw process 180 and the downstream process stations 120. Within the buffer zone 190, the glass ribbon 310 can be in a catenary form, i.e., a free hanging loop. The catenary shape can self-adjust depending on the amount of pull force and gravitational force imposed on the glass ribbon 310 in the buffer zone 190.

A glass ribbon 310 of low liquidus viscosity glass is formed by flowing molten low liquidus viscosity glass 300 into the float tank 160 and onto the surface of the molten metal bath 162 in a controlled manner. As the low liquidus viscosity glass ribbon 310 flows on the surface of the molten metal bath 162 over its length L_{M} towards the exit end 165 of the float tank 160, the low liquidus viscosity glass ribbon 310 thins and also spreads out wider. The speed of the glass ribbon 310 moving over the surface of the molten metal bath 162 is controlled so that the glass ribbon reaches its equilibrium thickness (i.e., the point at which the desired width and desired viscosity are reached) by the time the glass ribbon reaches the exit end 165 of the molten metal bath 162. As mentioned above, the length L_{M} of the molten metal bath 162 is no more than 5 meters long because the low liquidus viscosity glass reaches the equilibrium thickness faster than the conventional float glass composition which has higher liquidus viscosity. Also, limiting the length L_{M} of the molten metal bath 162, the chances of forming unwanted devit is minimized.

In some embodiments, a plurality of top edge surface rollers 170 can be provided for ensuring that the low liquidus viscosity glass ribbon 310 spreads to a desired width as it quickly reaches its equilibrium thickness. The plurality of top edge surface rollers 170 contact the upper surface of the glass ribbon 310 when the glass ribbon is on the surface of the molten metal bath 162 and the top edge surface rollers draw the glass ribbon 310 outward in a lateral direction with respect to the flow direction of the glass ribbon 310.

Referring to FIG. 2, which is a top-down view of the glass sheet manufacturing apparatus 100, two locations A and B are noted over the length L_{M} of the molten metal bath 162. At the location A, where molten low liquidus viscosity (<5 kP) glass in the form of a glass ribbon 310 enters the molten metal bath 162, the viscosity of the glass ribbon can be <10 kP with a thickness of about 22 mm. At the location B, near the exit end 165, the glass has spread and cooled to the point where the liquidus viscosity is at least 100 kP and can be up to 1 MP with a thickness of ˜7 mm. In this range of viscosity, the glass ribbon can be lifted from the molten metal bath 162 and turned into the vertical down-draw process by known mechanisms. In some embodiments, the glass sheet manufacturing apparatus 100 is capable of handling a ribbon 310 of a glass formulation whose liquidus viscosity is <1 kP.

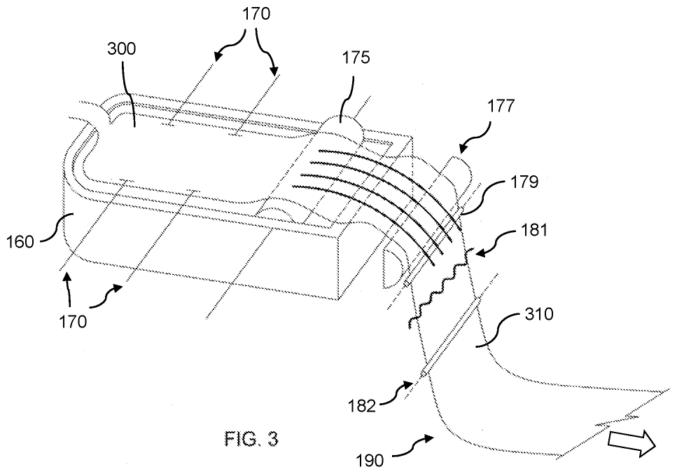

FIG. 3 shows the molten metal bath 162 of the present disclosure and the configuration for lifting the glass ribbon 310 out to the down-draw process 180 for further processing of the glass ribbon 310. As mentioned above, the plurality of top edge surface rollers 170 are provided at various points along the length L_{M} of the molten metal bath 162 and in contact with the top surface of the glass ribbon 310 to ensure that the glass spreads to the desired width as it reaches the equilibrium thickness. At the end of the molten metal bath 162, the glass ribbon 310 has reached the equilibrium thickness of ˜7 mm, however, still being in a viscous state with a liquidus viscosity of at least 100 kP up to 1 MP, the resulting ribbon of this low liquidus viscosity glass is not suitable for the horizontal downstream processes. The glass needs to be lifted out of the molten metal bath in a viscous state then directed into vertical down-draw processing. Preferably, this lift out is done without creating surface damages. This lifting can be accomplished by a lift out roller 175 immersed in the molten tin bath 162. After being lifted out, the glass ribbon 310 is turned vertical for the down-draw process 180. This turning can be accomplished by a full-width non-contacting turning device 177. Examples of the non-contacting turning device are air bearing rollers that are well known to those in the art. The non-contacting turning device 177 operates in conjunction with a glass speed control device 179. The glass speed control device 179 does not cause any surface damage to the glass ribbon 310. Examples of the glass speed control device 179 can be a set of edge rollers that pinch and drive only the edges of the glass ribbon. The region between the lift out roller 175 and the non-contacting turning device 177 is a thermally controlled zone 140 that keeps the glass ribbon 310 at proper temperature to maintain its viscosity between 100 kP up to 1 MP and above while the glass is in viscous state. In the down-draw process zone 180, the series of rollers 182 pull and stretch the glass ribbon 310 into a desired dimension as the ribbon cools. In this embodiment, the viscous to elastic transition occurs in the down-draw process zone near the rollers 182 in FIG. 3.

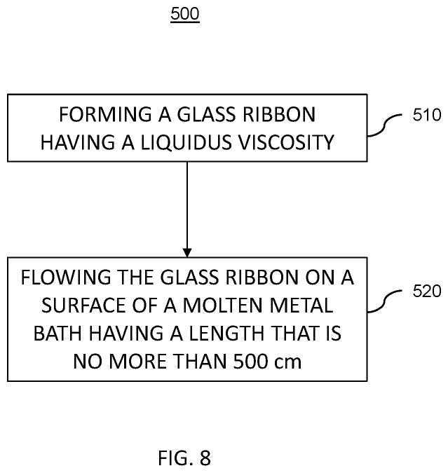

Referring to the flow chart 500 in FIG. 8, a method for forming a glass sheet from molten glass using the molten metal bath 162 is provided. The method comprises: forming a glass ribbon having a liquidus viscosity <5 kP, (see box 510); and flowing the glass ribbon on a surface of a molten metal bath 162 having a length defined between a first end A and a second end B that is no more than 500 cm (see box 520), wherein the glass ribbon flows over the length of the float tank in a flow direction from the first end to the second end such that the glass ribbon reaches its equilibrium thickness at the second end and the viscosity of the glass ribbon at the second end is at least 100 kP, preferably about 200 kP, and up to 1 MP.

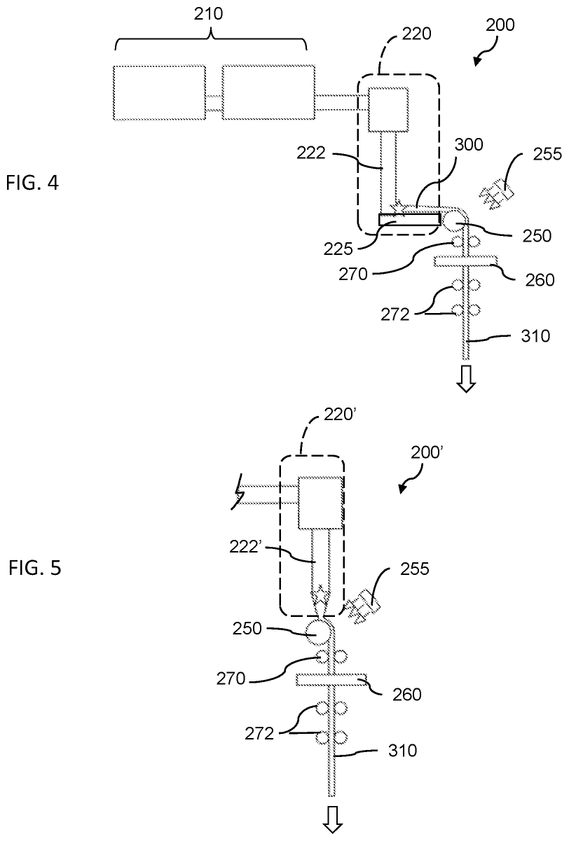

FIG. 4 is an illustration of an example of glass sheet forming apparatus 200 for low liquidus viscosity (<5 kP) glass utilizing horizontal delivery glass ribbon extraction method according to some embodiments. In this embodiment, the low liquidus viscosity glass is prepared in the standard melting and fining stations 210. The molten glass ribbon is then delivered to a cooling roller 250 via a horizontal delivery system 220. The cooling roller 250 absorbs heat from the glass ribbon and cools the glass ribbon. The horizontal delivery system 220 can comprise a molten glass dispenser 222 that dispenses a ribbon 310 of low viscosity glass onto an incline plate 225 that delivers the glass ribbon 310 horizontally to the cooling roller 250.

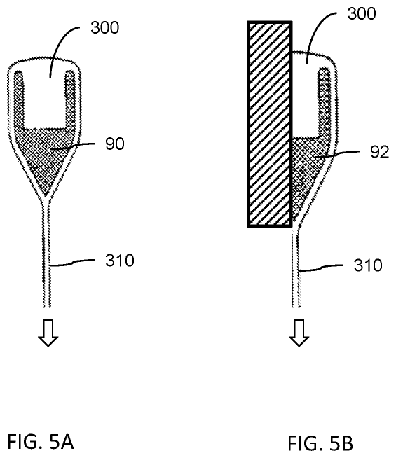

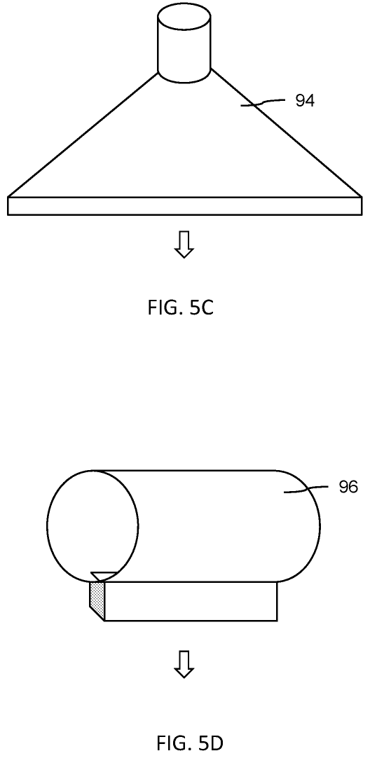

The molten glass dispenser 222 for the horizontal delivery system 220 can be one of the known molten glass delivery methods. Such molten glass delivery configurations are well known in the art. Some examples of such horizontal delivery molten glass dispenser are a fishtail, and a Pt (Platinum) tube with side slots, and other well-known devices. The horizontal delivery fish tail and the horizontal delivery Pt tube with side slots are similar to the vertical delivery systems shown in FIG. 5C (a vertical delivery fishtail slot 94) and FIG. 5D (a Pt tube 96 with an extended slot at the bottom), but configured for horizontal delivery. The molten glass ribbon 300 is dispensed on to the inclined plate 225.

When the ribbon 300 of a low liquidus viscosity glass exits the molten glass dispenser 222 the viscosity of the glass is <5 kP. As the glass ribbon 300 travels horizontally on the incline plate 225 and reaches the cooling roller 250, the viscosity can be at about 5-8 kP. In some embodiments, the glass sheet forming apparatus 200 is capable of handling a ribbon 300 of glass formulation whose liquidus viscosity is <1 kP and having a viscosity of about 1-3 kP when the glass ribbon 310 reaches the cooling roller 250. Thus, in this embodiment, the viscous to elastic transition point is in the down-draw process zone near the rollers 272 in FIGS. 4-5. The roller 250 provides at least two functions: (1) quickly (within a few seconds) cooling the glass ribbon 300 in a controlled manner to form a glass ribbon 310 having a workable viscosity of 100 kP-1 MP; and (2) orient the glass ribbon 310 into a vertical orientation for subsequent down-draw sheet forming processing of the glass ribbon 310 to reach the desired thickness, surface finish, etc.

The cooling roller 250 is configured to quickly cool the molten glass 300 within a few seconds to produce glass ribbon 310 having the desired viscosity of at least ˜100 kP and preferably ˜200 kP. The temperature of the molten glass is typically 1400-1600° C. depending on the composition. Depending on the composition, the temperature of the low liquidus viscosity glass at the desired viscosity is around 850-1000° C. However, the cooling needs to be in a controlled manner to accurately control the viscosity of the glass ribbon 310 coming off the cooling roller 250 while preventing formation of cosmetic defects in the glass ribbon. If the temperature of the cooling roller 250 is maintained too cold, the glass ribbon 310 can have cosmetic defects such as wavy surfaces known as chill wrinkles, or heavy orange peel, or cracks can form in the glass ribbon 310. In order to accurately control the cooling of the molten glass, the actively cooled roller 250 can comprise heating and cooling capability.

As shown in FIG. 4, a heater unit 255 can be provided in the proximity of the cooling roller 250 to heat the portion of the glass ribbon that is in contact with the cooling roller 250 as needed.

For controlling the heat extraction from the cooling roller 250 without physically interfering with the glass ribbon 310 that is rolling over on the outer surface of the roller 250, in some embodiments of the glass forming apparatus 200, the cooling roller 250 can be configured as a hollow cylinder and a liquid coolant is injected into the hollow interior space. As will be described in more detail below, the delivery of the liquid coolant can be configured so that the liquid coolant sprays on a desired portion of the interior wall of the cooling roller's hollow interior space.

Downstream from the cooling roller 250 can be various additional rollers 270 and 272 as shown in FIGS. 4 and 5. The downstream rollers 270 can be used to control the thickness of the glass ribbon 310. As necessary, reheating and/or surface polishing can be implemented downstream from the cooling roller 250. Laser based surface polishing and thickness tuning can also be implemented. These ancillary steps are schematically represented as 260 in FIGS. 4 and 5.

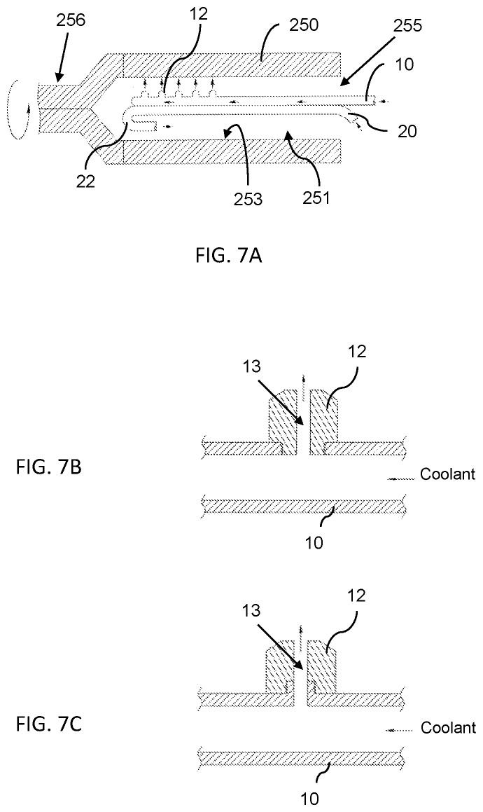

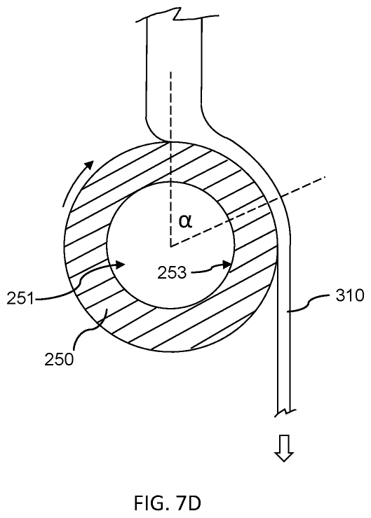

FIG. 7A is an illustration of an example of an internal cooling arrangement for delivering the liquid coolant to the interior space of the cooling roller 250. The cooling roller 250 is a hollow cylinder and comprises a hollow interior space 251 having an interior surface 253. The cooling roller 250 comprises an opening 255 on one end providing access to the hollow interior space 251. The opposite end 256 of the cooling roller 250 is configured to engage an appropriate driving mechanism that rotates the cooled roller which assists the conveyance of the glass ribbon 310. A liquid coolant supply pipe 10 comprising one or more jet nozzles 12 are positioned inside the hollow interior space 251 via the opening 255. When the cooling roller 250 needs to be cooled to maintain the temperature of its outer surface (that contacts the glass ribbon 310) at a desired temperature, a supply of liquid coolant is turned on to the supply pipe 10 and the liquid coolant exits the jet nozzles 12 and sprays on the interior surface 253 of the cooling roller 250. In order to avoid the liquid coolant from collecting and stagnating at the bottom of the interior space 251, a jet of gas (e.g. air or preferably inert gas) can be introduced via a gas supply pipe 20 to blow the liquid coolant out of the interior space 251. The gas supply pipe 20 is positioned inside the hollow interior space 251 via the opening 255. The terminal end 22 of the gas supply pipe 20 is preferably configured to direct the jet of gas in the direction of the opening 255 to blow the liquid coolant out of the interior space 251. Alternatively, rather than blowing the liquid coolant out, the pipe 20 can be used to remove the liquid coolant by suction. The liquid coolant can be water or other suitable liquid. Preferably, the water would be chemically treated to prevent corroding the cooling roller 250.

Referring to FIGS. 7B and 7C which are detailed illustrations of an exemplary structure for the jet nozzle 12. The jet nozzle 12 can be screwed into a threaded hole in the liquid coolant supply pipe 10 as shown in FIG. 7B. In the alternative, the jet nozzle 12 can be provided with a female type thread and be threaded onto a hole having a male type thread in the liquid coolant supply pipe 10 as shown in FIG. 7C. The jet nozzle 12 comprises a channel 13 that opens to the interior of the liquid coolant supply pipe 10 allowing the water to exit through the nozzle.

As shown in the cross-sectional view of the cooling roller 250 in FIG. 7D, the glass ribbon is dropped onto the cooling roller 250 near the top position of the rotating cooling roller 250. The sprays of liquid coolant exiting the jet nozzles 12 described above sprays on the interior wall 253 of the cooling roller and provide cooling. In some embodiments, the jet nozzles 12 can be provided in an array that directs the jet of liquid coolant in any preset direction and preferably in a selective direction so that a desired angular segment of the interior wall 253 can be selectively cooled. For example, if it is necessary to cool only certain portion of the cooling roller 250, the jet nozzles can be provided in an array that directs the jet of liquid coolant only in that angular segment portion of the interior wall of the cooling roller 250. As identified in FIG. 7D, the jet nozzles 12 can be arranged to direct the jets of liquid coolant only to the portion of the interior wall 253 that is within the angular segment a which is the section of the cooled roller 250 that is in contact with the hot glass ribbon 310.

With the jet nozzle 12 configuration, a range of heat removal rates can be achieved by tuning the liquid coolant temperature, tuning the amount of the liquid coolant delivered by controlling the flow rate of the liquid coolant, tuning the geometric configuration of the liquid coolant delivery hardware such as the density of the jet nozzles 12 (i.e. the spacing of the jet nozzles), the diameter of the jet nozzle channel 13, and the timing and frequency of the liquid coolant delivery ranging from a continuous supply, pulsing at various intervals, etc., to no supply. This cooling technology offers the additional advantage of being applicable to cooling other surfaces in the glass forming process.

Referring back to FIG. 4, the down-draw sheet forming process portion of the glass sheet forming process 200 can include a plurality of rolls such an edge rolls 270 (usually metal) and pulling rolls 272 (usually ceramic). The down-draw sheet forming process can also include one or more reheating units 260 to reheat the glass ribbon 310 as necessary. For example, if the glass ribbon 310 coming off the cooling roller 250 is too stiff for proper further forming process, the glass ribbon will need to be reheated to lower its viscosity in a controlled manner to make it more pliable. The sheet forming processing can also include additional processing to achieve desired surface attributes, such as laser based processing for glass ribbon thickness tuning and/or surface polishing.

FIG. 5 is an illustration of an example of glass sheet forming apparatus 200′ for low liquidus viscosity glass utilizing vertical delivery glass ribbon extraction method according to some embodiments. In this embodiment, the molten low liquidus viscosity glass is prepared in the standard melting and fining stations 210. The molten glass is then delivered to the cooling roller 250 via a vertical molten glass delivery system 220′. The vertical molten glass delivery system 220′ can comprise a vertical glass ribbon dispenser 222′ that delivers the ribbon of molten glass directly to the actively cooled roller 250.

The vertical glass ribbon dispenser 222′ for the vertical molten glass delivery system 220′ can be one of the known molten glass delivery methods. Some examples of such glass ribbon dispenser are an overflow fusion delivery device (see FIG. 5A), a single-sided overflow process, a single-sided overflow process from a half trough 92 (see FIG. 5B), a vertical fishtail slot 94 (see FIG. 5C), or a Pt tube 96 with an extended slot at the bottom (see FIG. 5D), etc. In each example illustration, the arrow indicate the direction of the flow of the molten glass being dispensed.

As the molten low viscosity glass exits the glass ribbon dispenser 222′ and lands on the cooling roller 250, the viscosity of the glass can be at about 5 kP. The viscous to elastic transition point is in the down-draw process around the pulling rolls 272 shown in FIG. 5. As in the embodiment shown in FIG. 4, the single-sided cooling roller 250 provides at least two functions: (1) quickly (within a few seconds) cooling the molten glass received from the glass ribbon dispenser 222′ in a controlled manner to form a glass ribbon 310 having a workable viscosity of ˜100 kP and preferably ˜200 kP; and (2) orient the glass ribbon 310 into a vertical orientation for subsequent down-draw sheet forming processing of the glass ribbon 310 to reach the desired thickness. The down-draw sheet forming process can include a plurality of rolls such an edge rolls 270 (usually metal) and pulling rolls 272 (usually ceramic). The down-draw sheet forming process can also include one or more reheating units 260 to reheat the glass ribbon 310 as necessary. For example, if the glass ribbon 310 coming off the cooling roller 250 is too stiff for proper further forming process, the glass ribbon will need to be reheated to lower its viscosity in a controlled manner to make it more pliable. The sheet forming processing can also include additional processing to achieve desired surface attributes, such as laser based processing for glass ribbon thickness tuning and/or surface polishing. In some embodiments, the glass sheet forming process 200′ is capable of handling a ribbon of glass formulation whose liquidus viscosity is <1 kP and having a viscosity of about 1-3 kP when the glass ribbon reaches the cooling roller 250.

As with the glass sheet forming process 200 of FIG. 4, the down-draw sheet forming process portion of the glass sheet forming process 200′ can include a plurality of rolls such an edge rolls 270 (usually metal) and pulling rolls 272 (usually ceramic). The down-draw sheet forming process portion can also include one or more reheating units 260 to reheat the glass ribbon 310 as necessary. For example, if the glass ribbon 310 coming off the single-sided cooling roller 250 is too stiff for proper further forming process, the glass ribbon will need to be reheated to lower its viscosity in a controlled manner to make it more pliable. The sheet forming processing can also include additional processing to achieve desired surface attributes, such as laser based processing for glass ribbon thickness tuning and/or surface polishing.

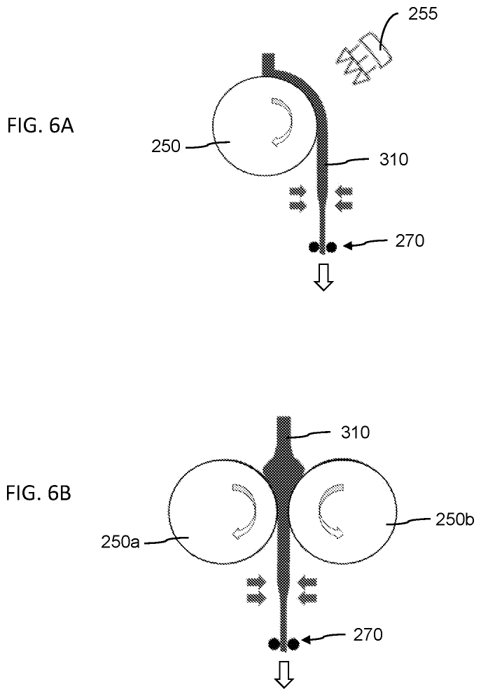

FIG. 6A is another illustration of the cooling roller 250 with the heater unit 255. In some embodiments, the controlled cooling of the molten glass 300 can be accomplished with a pair of cooling rollers 250a, 250b as shown in FIG. 6B. Depending on the particular composition of the low liquidus viscosity glass and the manufacturing throughput requirement, using a pair of the cooling rollers 250a, 250b can be desired because the two rolls can extract heat from the passing glass ribbon from two sides rather than one side. The cooling rollers 250, 250a, and 250b rotate in the direction with respect to the glass ribbon 310 noted by the arrows in FIGS. 6A and 6B. Thus, in the pair of cooling rollers 250a, 250b, the two rolls rotate in the opposite direction as noted so that the glass ribbon rolls through between the two rolls as shown. The cooling rollers rotate in the direction and at a speed that ensures that there is no relative movement between the roller and the glass ribbon 310 (i.e. no slippage) that is in contact with the rollers.

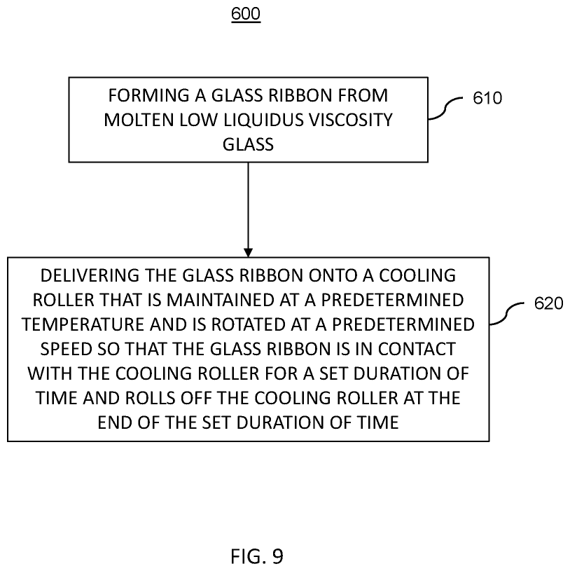

Referring to the flowchart 600 in FIG. 9 a method for forming a glass sheet from molten low liquidus viscosity glass using the apparatus 200 or 200′ according to another embodiment is provided. The method comprises: forming a glass ribbon from a molten glass whose liquidus viscosity is <5 kP, (see box 610); and delivering a glass ribbon onto a cooling roller, where the cooling roller is maintained at a predetermined temperature and is rotated at a predetermined speed so that the glass ribbon is in contact with the cooling roller for a set duration of time and rolls off the cooling roller at the end of the set duration of time, whereby the portion of the glass ribbon that is rolling off the cooling roller has attained a viscosity of at least ˜100 kP and preferably ˜200 kP, (see box 620). The effective viscosity will be around 100 kP to 1 MP. The glass ribbon coming off the cooling roller has a large temperature gradient through its thickness, thus an effective viscosity is used here to represent the mean viscosity. In such method, the glass ribbon can be delivered onto the cooling roller in a horizontal orientation (using the glass ribbon dispenser 222) or in a vertical orientation (using the glass ribbon dispenser 222′). In some embodiments of the method, the glass ribbon is delivered onto the cooling roller continuously.

Those skilled in the art will appreciate that many modifications to the exemplary embodiments described herein are possible without departing from the spirit and scope of the disclosure. Thus, the description is not intended and should not be construed to be limited to the examples given but should be granted the full breadth of protection afforded by the appended claims and equivalents thereto. In addition, it is possible to use some of the features of the present disclosure without the corresponding use of other features. Accordingly, the foregoing description of exemplary or illustrative embodiments is provided for the purpose of illustrating the principles of the present disclosure and not in limitation thereof and can include modification thereto and permutations thereof.

While preferred embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What is claimed is:

1. A method for forming a glass sheet from molten glass comprising:
forming a glass ribbon of glass whose liquidus viscosity is <5 kP; and
flowing the glass ribbon on a surface of a molten metal bath contained in a float tank having a length defined between a first end and a second end that is no more than 500 cm, wherein the glass ribbon flows over the length of the float tank in a flow direction from the first end to the second end such that the glass ribbon reaches its equilibrium thickness at the second end and the viscosity of the glass ribbon at the second end is at least 100 kP.

2. The method of claim 1, wherein the liquidus viscosity of the glass is <1 kP.

3. The method of claim 1, further comprising drawing the glass ribbon outward in a lateral direction with respect to the flow direction of the glass ribbon using a plurality of top rollers.

4. The method of claim 1, further comprising:
contacting an upper surface of the glass ribbon with a plurality of top rollers when the glass ribbon is on the surface of the molten metal bath; and
drawing the glass ribbon outward in a lateral direction with respect to the flow direction of the glass ribbon using the plurality of top rollers.

5. The method of claim 1, further comprising delivering the glass ribbon from the second end of the molten metal bath to a down-draw process that stretches and cools the glass ribbon.

6. An apparatus for forming a glass sheet from molten glass comprising:
a roller for receiving and cooling continuously-fed glass ribbon of glass whose liquidus viscosity is <5 kP, onto the roller's outer surface; and
a glass ribbon delivery device configured for continuously delivering the glass ribbon to the roller;
wherein the roller is configured to be maintained at a predetermined temperature and can be rotated at a predetermined speed so that the glass ribbon comes in contact with the roller for a set duration of time and rolls off the roller at the end of the set duration of time, whereby the portion of the glass ribbon that is rolling off the roller will attain a viscosity of at least 100 kP.

7. The apparatus of claim 6, wherein the liquidus viscosity of the glass is <1 kP.

8. The apparatus of claim 6, wherein the roller has a hollow cylindrical structure comprising an interior space having an interior wall, and the roller is configured for spraying a supply of liquid coolant onto at least a portion of the interior wall.

9. The apparatus of claim 7, wherein the roller comprises:
an opening at one of the hollow cylindrical structure providing access to the interior space;
a liquid coolant supply pipe extending into the interior space via the opening, wherein the liquid coolant supply pipe comprises one or more jet nozzles that sprays the liquid coolant onto a portion of the interior wall when a supply of liquid coolant is supplied to the liquid coolant supply pipe.

10. The apparatus of claim 8, wherein the jet nozzles are provided in an array that directs the spray of liquid coolant in a preset direction.

11. The apparatus of claim 8, wherein the jet nozzles are provided in an array that directs the spray of liquid coolant in a preset direction that covers a desired angular segment of the interior wall.

12. The apparatus of claim 6, wherein the glass ribbon delivery device is configured to deliver the continuously-fed glass ribbon horizontally to the roller.

13. The apparatus of claim 11, wherein the glass ribbon delivery device is a fishtail or a Pt tube with a side slot.

14. The apparatus of claim 6, wherein the glass ribbon delivery device is configured to deliver the continuously-fed glass ribbon vertically to the roller.

15. The apparatus of claim 13, wherein the glass ribbon delivery device is one of an overflow fusion delivery device, a single-sided overflow process, a single-sided overflow process from a half trough, a vertical fishtail slot, or a Pt tube with an extended slot.

16. A method for forming a glass sheet from molten glass comprising:
forming a glass ribbon from a molten glass whose liquidus viscosity is <5 kP; and
delivering the glass ribbon onto a roller, wherein the roller is maintained at a predetermined temperature and is rotated at a predetermined speed so that the glass ribbon is in contact with the roller for a set duration of time and rolls off the roller at the end of the set duration of time, whereby the portion of the glass ribbon that is rolling off the roller has a viscosity of at least 100 kP.

17. The method of claim 16, wherein the liquidus viscosity of the glass is <1 kP.

18. The method of claim 16, wherein the glass ribbon is delivered onto the roller in a horizontal orientation.

19. The method of claim 16, wherein the glass ribbon is delivered onto the roller in a vertical orientation.

20. The method of claim 16, wherein the glass ribbon is delivered onto the roller continuously.

21. The method of claim 18, wherein the glass ribbon is delivered onto the roller continuously.

22. The method of claim 19, wherein the glass ribbon is delivered onto the roller continuously.

23. The method of claim 16, further comprising delivering the glass ribbon from the roller to a down-draw process that stretches and further cools the glass ribbon in to a desired dimension.

24. An apparatus for forming a glass sheet from molten glass comprising:
a pair of rollers for receiving and cooling continuously-fed glass ribbon of glass whose liquidus viscosity is <5 kP, onto the pair of rollers' outer surfaces between the two rollers; and
a glass ribbon delivery device configured for continuously delivering the glass ribbon to the pair of rollers;
wherein the two rollers are maintained at a predetermined temperature and is rotated at a predetermined speed so that the glass ribbon is in contact with the two rollers for a set duration of time and rolls off the two rollers at the end of the set duration of time, whereby the portion of the glass ribbon that is rolling off the two rollers has a viscosity of at least 100 kP.

25. The apparatus of claim 24, wherein the liquidus viscosity of the glass is <1 kP.

26. The apparatus of claim 24, wherein each of the two rollers has a hollow cylindrical structure comprising an interior space having an interior wall, and the roller is configured for spraying a supply of liquid coolant onto at least a portion of the interior wall.

27. The apparatus of claim 24, wherein each of the rollers comprises:
an opening at one of the hollow cylindrical structure providing access to the interior space;
a liquid coolant supply pipe positioned inside the interior space via the opening, wherein the liquid coolant supply pipe comprises one or more jet nozzles that sprays the liquid coolant onto a portion of the interior wall when a supply of liquid coolant is supplied to the liquid coolant supply pipe.

28. The apparatus of claim 27, wherein the jet nozzles are provided in an array that directs the spray of liquid coolant in a preset direction.

29. The apparatus of claim 27, wherein the jet nozzles are provided in an array that directs the spray of liquid coolant in a preset direction that covers a desired angular segment of the interior wall.

30. The apparatus of claim 24, wherein the glass ribbon delivery device is configured to deliver the continuously-fed glass ribbon horizontally to the pair of rollers.

31. The apparatus of claim 30, wherein the glass ribbon delivery device is a fishtail or a Pt tube with a side slot.

32. The apparatus of claim 24, wherein the glass ribbon delivery device is configured to deliver the continuously-fed glass ribbon vertically to the pair of rollers.

33. The apparatus of claim 32, wherein the glass ribbon delivery device is one of an overflow fusion delivery device, a single-sided overflow process, a single-sided overflow process from a half trough, a vertical fishtail slot, or a Pt tube with an extended slot.
